(19) United States
(12) Patent Application Publication
(10) Pub. No.: US 2007/0146904 A1
(43) Pub. Date: Jun. 28, 2007

(54) Submersive doublet for high numerical aperture optical system

(76) Inventor: James Edson Webb, Fairport, NY (US)

Correspondence Address: CORNING INCORPORATED, SP-TI-3-1, CORNING, NY, 14831, US

(21) Appl. No.: 11/644,299

(22) Filed: Dec. 22, 2006

Related U.S. Application Data
(60) Provisional application No. 60/597,897, filed on Dec. 22, 2005.

(51) Int. Cl. G02B 9/00

(52) U.S. Cl. 359/796

(57) ABSTRACT

The invention features a doublet at one end of a high numerical aperture imaging system. The doublet includes two members coupled together by a fluid medium. The first member is arranged for receiving converging rays within a region of medium power density, and the second member further converges the rays through a region of higher power density. The second member can be made to withstand the higher power density by being made of a more durable material or in a form that is easily replaceable.

### FIELD OF THE INVENTION

The invention relates to imaging systems, especially high numerical aperture microlithographic imaging systems operating within the deep ultraviolet spectrum, and to lens elements subject to high concentrations of light energy adjacent to the image or object planes of these or similar imaging systems.

### BACKGROUND OF THE INVENTION

The end optic of high numerical aperture imaging systems (i.e., NA's of 0.85 or greater) can experience relatively high concentrations of light energy, particularly if the image is also reduced. For example, the last optic adjacent to the image plane of a high NA reducing system concentrates light toward image points through a wide range of angles. The light concentrations can alter or damage the optical materials in which light is concentrated. The problem is particularly apparent in microlithographic imaging systems operating in the deep UV, where in addition to the high concentrations of photons, the energies of the photons are relatively high. The attendant damage to optical materials can include gradual changes in refractive index or a reduction in transmissivity.

High index materials are preferred as the last optic of high numerical aperture systems, particularly in immersive imaging systems, for achieving the high numerical aperture objectives of such systems. The last optic should have a refractive index at least as high as the immersion fluid coupling the last optic to the image plane. Special advantages associated with materials having indices greater than 1.8 are discussed in a paper co-authored by James Webb entitled “High-index Materials for 193 nm Immersion Lithography” from Proceedings of SPIE Vo. 5754—Optical Microlithography XVIII, which is hereby incorporated by reference. However, for the designs contemplated, the manufacturing (e.g., growth) such high index materials (e.g., sapphire, ceramic spinel, lutetium aluminum garnet, or germanium garnet) at the required size and quality is not practical.

### BRIEF SUMMARY OF THE INVENTION

An end optic of a high numerical aperture imaging system is formed as a doublet having first and second members coupled together by a high index fluid. The first member of the doublet is located within a region of moderate power density. The second member of the doublet is located within a region of higher power density. The first member can be made of conventional optical materials appropriate for the desired frequency band. The second member is preferably made of a more durable material capable of withstanding the higher expected power density. The second element also preferably adds power for increasing the numerical aperture. Alternatively, the second member could be formed as a planar optic made of a not so durable material but arranged for easy replacement.

One version of the invention as a submersible doublet for an optical imaging system includes first and second optically transmissive members optically coupled together by a fluid medium having a refractive index greater than air. The first member of the doublet is arranged for propagating light at a first power density, and the second member of the doublet is arranged for propagating light at a second higher power density. The second member has respective fluid interfaces with (a) the fluid medium optically coupling the second member to the first member and (b) an immersion fluid medium for optically coupling the second member to a conjugate plane, such as an image or object plane. The second member is made of a more durable material than the first member for withstanding the second higher power density.

Preferably, the first member has an outer surface that is convex and an inner surface that forms a part of the fluid interface with the fluid medium optically coupling the first member to the second member. The inner surface of the first member can be concave, and the second member can have an inner surface that is convex, forming another part of the fluid interface for optically coupling the first member to the second member. The second member preferably has an outer surface that is planar for forming a part of the fluid interface for optically coupling the second member to the conjugate plane.

The first and second members have radial dimensions normal to a common optical axis and the radial dimension of the second member is preferably smaller than the radial dimension of the first member. The smaller radial dimension allows more materials, including more durable high refractive index materials to be used for the second member. The second member preferably has a refractive index higher than the refractive index of the first member. For example, the second member can be fashioned from a material that is optically transmissive below 200 nanometers and has a refractive index greater than 1.8. Such high-index, deep-UV transmissive material can be selected from a group consisting of sapphire, crystalline spinel, ceramic spinel, lutetium aluminum garnet, and germanium garnet. On the other hand, the first member is preferably made from fused silica or calcium fluoride.

The fluid medium optically coupling the second member to the first member preferably has a refractive index greater than water. The immersion fluid medium optically coupling the second member to the conjugate plane can be the same material as the fluid medium optically coupling the second member to the first member. However, the second member preferably has a refractive index greater than the fluid medium optically coupling the first and second members.

Another version of the invention features a submersible doublet of a projection optical imaging system that projects an image of an object onto a substrate. An end optic of the projection optical system located adjacent to the substrate includes first and second optically transmissive members coupled together by a fluid medium having a refractive index greater than air, The first member of the optic collects converging rays at a first level of power density, and the second member of the optic further converges rays toward a focus on the substrate at a second level of power density, An immersion fluid medium optically couples the second member to an imaging plane. The second level of power density is higher than the first level of power density, and the second member is arranged to accommodate a higher level of power density than the first member.

For example, the second member can be made of a more durable material than the first member to withstand the higher level of power density. For such purposes as projection imaging in the deep UV (less than 300 nanometer wavelengths), the second member can be made of a optically transmissive material having a refractive index of greater than 1.8. Such high-index, deep-UV transmissive materials can be selected from a group consisting of sapphire, crystalline spinel, ceramic spinel, lutetium aluminum garnet, and germanium garnet. In such instance, the first member is preferably made from fused silica or calcium fluoride.

The first member can have an entry surface that is convex and an exit surface that is concave, and the second member can have an entry surface that is convex and an exit surface that is plane parallel. The first and second members have radial dimensions normal to a common optical axis and the radial dimension of the second member is preferably smaller than the radial dimension of the first member. Similarly, the first and second members have respective thicknesses along a common optical axis and the thickness of the second member is preferably less than the thickness of the first member. The fluid medium optically coupling the second member to the first member has a refractive index greater than water.

Alternatively, the second member can be made as a plane parallel optic arranged for replacement within the doublet. The plane-parallel form allows easy removal and replacement of the second member within the imaging system. In such instance, it is preferred that the fluid medium used for optically coupling the second member to the first member is the same material as the immersion fluid medium that optically couples the second member to an imaging plane,

Another version of the invention as a projection optical system includes a projection lens having a high numerical aperture greater than 0.85 for transferring an image of an object onto a substrate. An end optic of the projection lens has an immersive interface with the substrate. The end optic is formed as a doublet having a first member that collects converging rays at a first level of power density and a second member that further converges rays toward a focus on the substrate at a second level of power density. A fluid medium having a refractive index equal to or greater than the refractive index of water optically couples the first and second members together. The second level of power density is higher than the first level of power density, and the second member accommodates a higher level of power density than the first member.

The second member can be made of a more durable material than the first member. For accommodating the objectives of the projection system, the second member can be made of a optically transmissive material, such as those listed above, having a refractive index of greater than 1.8 for optical transmissions less than 200 nanometer wavelengths.

The first member can have an entry surface that is convex and an exit surface that is concave, and the second member can have an entry surface that is convex and an exit surface that is plane parallel. The first and second members can also be shaped and dimensioned as mentioned above.

Alternatively, the second member can be made as a plane parallel optic arranged for replacement within the doublet. The fluid medium optically coupling the second member to the first member can be the same material as an immersion fluid medium optically coupling the second member to the substrate.

The invention among its various embodiments accommodates high power densities associated with high numerical aperture systems operating in the deep UV using durable high-index materials within regions of highest power density and relatively shapes the high-index materials for increasing the numerical aperture or reducing the aperture dimensions of the optics leading to the doublet. Alternatively, the invention accommodates high power density by fashioning a portion of an end optic as a replaceable plate.

### BRIEF DESCRIPTION OF THE DRAWING FIGURES

FIG. 1 is a schematic representation of a microlithographic stepper in which the final element adjacent to the image plane is a submersive doublet.

FIG. 2 is a schematic diagram of an illuminator lens and a projector lens for magnifying an image of an illuminated reticle through the submersive doublet adjacent to the image plane.

FIG. 3 is a cross-sectional view of a doublet arranged in accordance with the invention.

FIG. 4 is a cross-sectional view of an alternative doublet arranged in accordance with the invention.

### DETAILED DESCRIPTION OF THE INVENTION

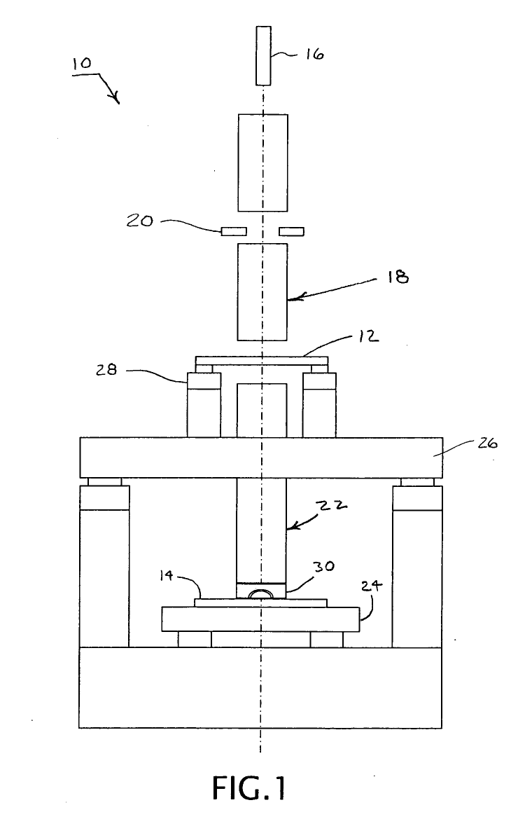

With reference to FIG. 1, a microlithographic stepper (or scanner) 10 of a type that can particularly benefit from the invention transfers a pattern formed on a reticle 12 onto a substrate 14. The reticle 12 is illuminated by light produced by a laser source 16 and shaped by an illuminator lens 18 designed to produce a uniform irradiance field at the substrate 14. A shutter 20 interrupts the illuminator lens 18 for controlling exposure duration.

A projection lens 22 both reduces and transfers the reduced image of the illuminated reticle pattern onto the substrate 14. A stage 24 provides for translating or rotating the substrate 14 with respect to the projection lens 22 and reticle 12 to perform the required stepping or scanning operations for transferring one or more reticle patterns over different areas of the substrate 14. The projection lens 22 and the reticle 12 are also carried on respective stages 26 and 28 for purposes of focusing, alignment, and other imaging considerations.

The projection lens 22 meets stringent resolution requirements for accurately reproducing closely spaced features of the reticle patterns. Features are now commonly resolvable to dimensions in the range of 110 nanometers or less, but feature sizes in the range of 65 nanometers or less are preferred. In addition to using high quality optics and targeted angular and spatial irradiance profiles, resolution requirements are achieved by a combination of short wavelength illumination and high numerical aperture imaging. The shorter wavelengths include wavelengths less than 250 nanometers, such as produced by 248 nm Krypton-Fluorine (KrF) Excimer lasers but wavelengths less than 200 nanometers are preferred, such as produced by 193 nm Argon-Fluoride (ArF) Excimer lasers. The high numerical apertures include numerical apertures greater than 0.85, preferably above 1.0 and more preferably approaching 1.5 or greater.

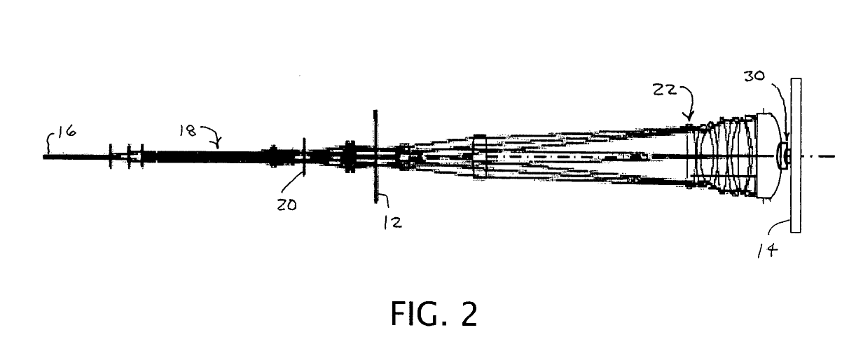

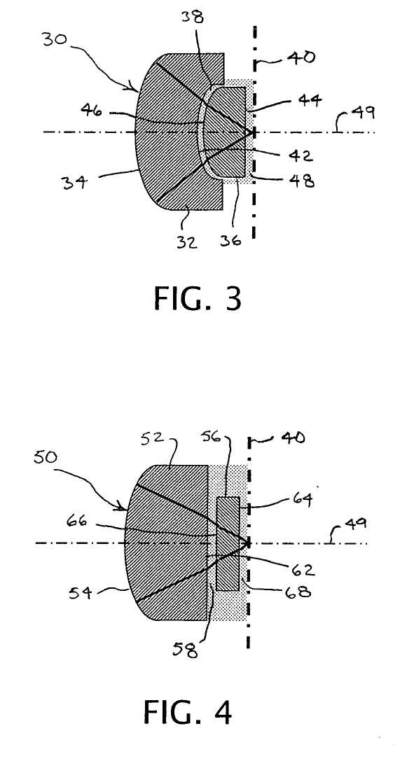

Within the projection lens 22, which functions as a high numerical aperture reducing lens, an end optic (e.g., “last glass”) as shown in FIG. 2 is arranged as a doublet 30. The doublet 30, which is shown better in FIG. 3, is divided into a first member 32 having a convex (outer) entry surface 34 and a second member 36 made of a material that can accommodate high power density, including repeated exposures at high power density over the expected service life of the second member 36. The second member 36 is coupled to the first member 32 through a fluid immersion interface 38 that is filled with a fluid having a refractive index not less the refractive index of the first member 32 to assure adequate coupling by avoiding conditions for total internal reflection. The same immersion fluid can be used at a second fluid immersion interface 48 for coupling the second member 36 to an image plane 40, although a different immersion fluid with the same or a different refractive index could also be used. For example, an immersion fluid with a higher index at the second fluid immersion interface 48 could be used to exploit an increase in the refractive index of the second member 36.

A convex entry (inner) surface 46 of the second member 36 preferably matches a concave exit (inner) surface 42 within the first member 32. The two inner surfaces 46 and 42 of the first and second members 32 and 36 defined boundaries of the immersion interface 38. The higher refractive index of the second member 36 in conjunction with its convex entry (inner) surface 46 can be arranged for increasing the numerical aperture of the doublet 30 or for reducing the aperture dimensions of the optics leading to the doublet 30.

The second member 36 can be a uniaxial crystal, such as sapphire, or other high-index optical material, such as crystalline spinel (MgAl₂O₄), ceramic spinel, magnesium oxide (MgO), lutetium aluminum garnet (Al₅Lu₃O₁₂), or germanium garnet, capable of accommodating the expected power density. Any birefringence arising as a result of the material choice for either member 32 or 36 can be accommodated by limiting the transmission length through the member, regulating the polarization of the transmitted light, such as by using radial/azimuthal polarization within telecentric object/image space, or relatively clocking other birefringent materials (e.g., CaF2) within the projection lens 22. Non-birefringent materials, such as ceramic spinel or Yittrium aluminum garnet (YAG) optics, could also be used for both members 32 and 36 of the doublet 30.

The second member 36 is sized in thickness between its convex entry (inner) surface 46 and a planar exit (outer) surface 44 along a common optical axis 49 of the first and second members 32 and 36 by the amount required to accommodate the expected high concentrations of light energy that could damage less durable materials. That is, the second member 36 replaces the portion of the first member 32 that cannot similarly accommodate the expected power density. The thickness of the second member 16 can also be adjusted to provide a balanced clocking effect, where the birefringence of the first member 32 is stronger than the birefringence of the second member 36.

The second member 36 is also sized in a radial dimension normal to the optical axis 49 to match the smaller volume of light approaching a focus at a conjugate plane such as the image plane 40. This reduces the size requirements of the second member 36 with respect to the first member 32, and, along with the limited thickness of the second member 36, allows a wider choice of materials to be used for constructing the second member 36 to accommodate the expected power densities approaching the focus and to achieve higher numerical apertures NA or smaller aperture dimensions of the preceding optics.

The first member 32 is preferably made of calcium fluoride (CaF2) fused silica. The refractive index of calcium fluoride (CaF2) is approximately 1.5, fused silica is approximately 1.56, whereas the refractive index of water is approximately 1.44 for 193 nm wavelengths. Immersion fluids having a refractive index higher than water are preferred. Such high-index immersion fluids include water doped with salts or acids, alcohol and its derivatives, phosphoric acid, and specialty fluids, e.g., HIF-001, with an ˜1.64 index at 193 nm wavelength from JSR Micro, Inc. of Sunnyvale, Calif. The high-index materials preferred for the second member 36 have indices of 1.8 or greater at their intended wavelengths of use. For example, the refractive indices of magnesium oxide (MgO) and lutetium aluminum garnet (Al₅Lu₃O₁₂) are approximately 2.1 at 193 nm wavelengths. Crystalline spinel and ceramic spinel have refractive indices near 1.9 at the same wavelength.

Further increasing the refractive index of the immersion fluid interface 48 with the image plane 40 has the effect of increasing the depth of focus without changing the numerical aperture. The refractive index “n” increases but the inclination angle θ with respect to the optical axis decreases. In other words, the effective wavelength gets shorter (which increases resolution) but the angle though which light is collected becomes smaller (which decreases resolution).

The refractive index of the second member 36 is preferably not less than the refractive index of the fluid within immersion fluid interface 38 so as not to give up any potential for achieving a high numerical aperture NA. The refractive index sets a limit on how high the numerical aperture NA can get over 1, because the maximum of the sine function is 1.

A ratio of refractive indices between the second member 36 and the immersion fluid 38 can be maintained so that the other optics of the design can remain substantially unchanged (e.g., does not alter the spherical aberration). For example, a ratio of CaF2 to water is around 1.04. With an immersion fluid 38 having a refractive index of 1.65, the second member 36 could have a matching ratio refractive index of 1.72.

As shown in FIG. 4, first and second members 52 and 56 of an alternative doublet 50 meet at a first planar interface 58 filled with an immersion fluid. The second member 56 of a doublet 50 can be formed as a planar optic if used solely for the accommodation of power density and not for contributing to a higher numerical aperture NA. The second member 56 could also be formed as a replaceable planar optic of a conventional material, such as fused silica or calcium fluoride, which can be periodically replaced as subjected to damage. In planar form, the second member 56 can be easily replaced.

The first member 52 has an entry (outer) surface 54 that is convex and an exit (inner) surface 62 that is planar. The second member 56 has a planar entry (inner) surface 66 and a planar exit (outer) surface 64. The inner surfaces 62 and 66 of the first and second members 52 and 56 define boundaries of the first immersion interface 58. The planar exit surface 64 of the second member 56 defines, together with the image plane 40 on a substrate 14 (shown in FIGS. 1 and 2), a second planar immersion interface 68, which is shown filled with the same immersion fluid as the first planar immersion interface 58. Different immersion fluids can also be used for the two interfaces 58 and 68 as discussed for the preceding embodiment.

The thickness of the plane parallel second member 56 is preferably set to occupy the region where the power density is expected to damage conventional optical materials such as fused silica or calcium fluoride. Nonetheless, the second member can be made of such conventional optical materials if otherwise arranged for ready removal and replacement. Otherwise, more durable materials, such as those suggested for the second member 36 of the preceding embodiment, are preferably used.

The second optic 56 is also depicted with a reduced radial dimension covering the operative region intended for propagating light to focus, which makes its fabrication with durable materials more practical. However, if made of conventional optical materials, the radial dimension can be set to best accommodate its ready removal and replacement.

The invention is particularly suitable for use with photolithographic imaging systems of steppers or scanners, such as those known for use manufacturing semiconductors or flat panel displays. However, other high-power imaging systems subject to damage from high power densities can also benefit from the invention. The invention can be used at either end of imaging systems, but is especially intended for the high numerical aperture NA end of the optical systems.

1. A submersible doublet for an optical imaging system comprising
first and second optically transmissive members optically coupled together by a fluid medium having a refractive index greater than air,
the first member of the doublet being arranged for propagating light at a first power density,
the second member of the doublet (a) being arranged for propagating light at a second higher power density and (b) having respective fluid interfaces with both the fluid medium optically coupling the second member to the first member and an immersion fluid medium for optically coupling the second member to a conjugate plane, and
the second member being made of a more durable material than the first member for withstanding the second higher power density.

2. The doublet of claim 1 in which the first member has an outer surface that is convex and an inner surface that forms a part of the fluid interface with the fluid medium optically coupling the first member to the second member.

3. The doublet of claim 2 in which the inner surface of the first member is concave, and the second member has an inner surface that is convex and forms another part of the fluid interface with the fluid medium optically coupling the first member to the second member.

4. The doublet of claim 3 in which the second member has an outer surface that is planar for forming a part of the fluid interface with the immersion fluid medium for optically coupling the second member to the conjugate plane.

5. The doublet of claim 3 in which the first and second members have radial dimensions normal to a common optical axis and the radial dimension of the second member is smaller than the radial dimension of the first member.

6. The doublet of claim 1 in which the fluid medium optically coupling the second member to the first member has a refractive index greater than water.

7. The doublet of claim 1 in which the fluid medium optically coupling the second member to the first member is the same material as the fluid medium for optically coupling the second member to the conjugate plane.

8. The doublet of claim 1 in which the second member has a refractive index greater than the fluid medium optically coupling the first and second members.

9. The doublet of claim 1 in which the second member has a refractive index higher than the first member.

10. The doublet of claim 9 in which the second member is optically transmissive below 200 nanometers and has a refractive index greater than 1.8.

11. The doublet of claim 1 in which the second member is a high-index, deep-UV transmissive material selected from a group consisting of sapphire, crystalline spinel, ceramic spinel, lutetium aluminum garnet, and germanium garnet.

12. The doublet of claim 11 in which the first member is made from one of fused silica and calcium fluoride.

13. A submersible doublet of a projection optical imaging system that projects an image of an object onto a substrate comprising
an end optic located adjacent to the substrate and including first and second optically transmissive members coupled together by a fluid medium having a refractive index greater than air,
the first member of the optic being arranged for collecting converging rays at a first level of power density,
the second member of the optic being arranged for further converging rays toward a focus on the substrate at a second level of power density,
an immersion fluid medium optically coupling the second member to an imaging plane,
the second level of power density being higher than the first level of power density, and
the second member being arranged to accommodate a higher level of power density than the first member.

14. The doublet of claim 13 in which the second member is made of a more durable material than the first member to withstand the higher level of power density.

15. The doublet of claim 14 in which the second member is made of a optically transmissive material having a refractive index of greater than 1.8 for optical transmissions less than 200 nanometer wavelengths.

16. The doublet of claim 14 in which the second member is a high-index, deep-UV transmissive material selected from a group consisting of sapphire, crystalline spinel, ceramic spinel, lutetium aluminum garnet, and germanium garnet.

17. The doublet of claim 15 in which the first member is made from one of fused silica and calcium fluoride.

18. The doublet of claim 13 in which the second member is made as a plane parallel optic arranged for replacement within the doublet.

19. The doublet of claim 18 in which the fluid medium used for optically coupling the second member to the first member is the same material as the immersion fluid medium that optically couples the second member to an imaging plane.

20. The doublet of claim 13 in which the first member has an entry surface that is convex and an exit surface that is concave, and the second member has an entry surface that is convex and an exit surface that is plane parallel.

21. The doublet of claim 20 in which the first and second members have radial dimensions normal to a common optical axis and the radial dimension of the second member is smaller than the radial dimension of the first member.

22. The doublet of claim 13 in which the first and second members have respective thicknesses along a common optical axis and the thickness of the second member is less than the thickness of the first member.

23. The doublet of claim 13 in which the fluid medium optically coupling the second member to the first member has a refractive index greater than water.

24. The doublet of claim 13 in which the fluid medium optically coupling the second member to the first member is the same material as the immersion fluid medium for optically coupling the second member to the imaging plane.

25. A projection optical system comprising
a projection lens having a high numerical aperture greater than 0.85 for transferring an image of an object onto a substrate,
an end optic of the projection lens having an immersive interface with the substrate,
the end optic being formed as a doublet having a first member that collects converging rays at a first level of power density and a second member that further converges rays toward a focus on the substrate at a second level of power density,
a fluid medium optically coupling the first and second members and having a refractive index equal to or greater than the refractive index of water,
the second level of power density being higher than the first level of power density, and
the second member being arranged to accommodate a higher level of power density than the first member.

26. The system of claim 25 in which the second member made of a more durable material than the first member.

27. The system of claim 26 in which in which the second member is made of a optically transmissive material having a refractive index of greater than 1.8 for optical transmissions less than 200 nanometer wavelengths.

28. The doublet of claim 27 in which the second member is a high-index, deep-UV transmissive material selected from a group consisting of sapphire, crystalline spinel, ceramic spinel, lutetium aluminum garnet, and germanium garnet.

29. The doublet of claim 25 in which the second member is made as a plane parallel optic arranged for replacement within the doublet.

30. The doublet of claim 25 in which the first member has an entry surface that is convex and an exit surface that is concave, and the second member has an entry surface that is convex and an exit surface that is plane parallel.

31. The doublet of claim 31 in which the first and second members have radial dimensions normal to a common optical axis and the radial dimension of the second member is smaller than the radial dimension of the first member.

32. The doublet of claim 32 in which the first and second members have respective thicknesses along a common optical axis and the thickness of the second member is less than the thickness of the first member.

33. The doublet of claim 25 in which the fluid medium optically coupling the second member to the first member is the same material as a fluid medium for optically coupling the second member to the substrate.
